(19) United States
(12) Patent Application Publication
(10) Pub. No.: US 2007/0109175 A1
(43) Pub. Date: May 17, 2007

(54) SPREAD SPECTRUM RADAR APPARATUS

(75) Inventor: Takeshi FUKUDA, Osaka, (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/425,219

(22) Filed: Jun. 20, 2006

(30) Foreign Application Priority Data
Jun. 22, 2005 (JP) 2005/182616

(51) Int. Cl. G01S 13/08; G01S 13/93

(52) U.S. Cl. 342/70; 342/71; 342/131; 342/132; 342/134; 342/137; 342/159; 342/82; 342/85

(57) ABSTRACT

A spread spectrum radar apparatus includes: a pseudo-noise code generation unit that generates two or more transmitter pseudo-noise codes which are respectively different and two or more receiver pseudo-noise codes which are respectively different, based on a timing signal; a spreading modulation unit that generates a spread signal by modulating a signal having a predetermined frequency in plural stages, using the two or more transmitter pseudo-noise codes individually in the respective stages; a transmission unit that emits the spread signal as the detection radio wave; a reception unit that receives, as a received signal, the detection radio wave reflected back from the object; a despreading modulation unit that generates a despread signal by modulating the received signal, using the two or more receiver pseudo-noise codes individually in the respective stages; and a signal processing unit that detects presence of the object in accordance with a signal intensity of at least a specific frequency component, based on the despread signal.

### BACKGROUND OF THE INVENTION

(1) Field of the Invention

The present invention relates to a radar apparatus utilizing a spread spectrum scheme, and particularly relates to a sophisticated spread spectrum radar apparatus with a high capability of object detection.

(2) Description of the Related Art

In recent years, a considerable effort has been made on technological development of radar apparatuses mounted on vehicles (hereinafter referred to as “on-vehicle radar apparatuses”). For example, there has been proposed a radar apparatus or the like utilizing a spread spectrum scheme (hereinafter referred to as the “spread spectrum radar apparatus”) (for example, refer to Japanese Laid-Open Patent Application No. 07-12930).

On-vehicle radar apparatuses are used for detection of a preceding car, an obstacle located backward, and the like, for the purpose of safety improvement such as collision avoidance and enhancement of the driving convenience represented by reverse driving support. When the on-vehicle radar apparatuses are used for such purposes, it is necessary to suppress the influence of undesired radio waves from another radar apparatus of the same type. For example, interference by an electromagnetic wave emitted from a radar apparatus of the same type mounted on another vehicle should be suppressed.

In contrast, a spread spectrum radar apparatus is capable of suppressing the influence of undesired radio waves since a radio wave to be transmitted is modulated using a pseudo-noise code (hereinafter referred to as the “PN code”) for spectrum spreading and thus a radio wave that has been modulated using a different code is suppressed within the receiver. Similarly, undesired radio waves emitted from a radar apparatus of another type in which no code modulation is performed, are suppressed within the receiver. Furthermore, since the radio wave to be transmitted is frequency-spread using a PN code, it is possible to minimize the electric power per unit frequency and thus to reduce the influence on other wireless systems. It is also possible to freely set a relationship between distance resolution and maximum detectable range by adjusting the chip rate and code period of the PN code. It is further possible to reduce the peak power since continuous transmission of radio waves is possible. With the above features, it is possible to use even a frequency band in which electric power per unit frequency is set to low by laws and regulations.

FIG. 1 is a diagram showing a general structure of a spread spectrum radar apparatus having superior features as described above.

As shown in FIG. 1, the spread spectrum radar apparatus 300 includes a timing generation unit 301, a PN code generation unit 302, a signal source 303, a transmission spreading modulation unit 304, a transmission unit 305, a transmission antenna 306, a reception antenna 307, a reception unit 308, a reception spreading modulation unit 309, a signal processing unit 310, a distance measurement code delay unit 311, and the like.

Next, an operation of the conventional spread spectrum radar apparatus 300 is described. At the transmitter side, a narrow-band signal generated by the signal source 303 is spectrum-spread over a wide band by the transmission spreading modulation unit 304, using a PN code generated by the PN code generation unit 302. Then, the resulting radio wave goes into the transmission unit 305 having functions such as frequency transform and amplification, and is emitted from the transmission antenna 306 as an object detection radio wave used for object detection. Here, the transmission spreading modulation unit 304 is configured, in general, of a biphase modulator (BPSK modulator) such as a balanced mixer. The transmission spreading modulation unit 304 spreads the frequency band of an input signal, by phase-modulating the input signal using two phases of 0 degree and 180 degree. Through this spreading modulation, it is possible to minimize the electric power per unit frequency of the detection radio wave emitted from the transmission antenna 306.

Next, at the receiver side, a detection radio wave reflected from an object is received by the reception antenna 307. Then, the received detection radio wave is goes through the reception unit 308 configured of a low-noise amplifier, a frequency transformer, or the like, and is despread by the reception spreading modulation unit 309, using a “PN code f”; which is obtained by the distance measurement code delay unit 311 performing time delay on the “PN code e” supplied to the transmission spreading modulation unit 304. At this time, when there is a match between (i) a delay time that corresponds to the round trip time delay of the detection radio wave attributable to the distance to the object from which the detection radio wave has been reflected (such an object is hereinafter referred to as a “reflection object”) and (ii) the delay time produced by the distance measurement code delay unit 311, it indicates that the phase of the code included in the “signal c” outputted from the reception unit 308 matches the phase of the “PN code f” outputted from the distance measurement code delay unit 311. Thus, the same signal as that of the “signal a” outputted from the signal source 303 is reconstructed as the “signal d” outputted from the reception spreading modulation unit 309, and the frequency components of the “signal d” becomes the same as those of the “signal a” being a narrow-band signal. Meanwhile, in the case where the delay time produced by the distance measurement code delay unit 311 is different from the round trip time delay of the detection radio wave, the signal represented by the “signal d” remains in a state where its frequency is spread over a wide band without being despread. It is possible for the signal processing unit 310 to detect whether or not there exists a reflection object at a location which is away by a distance that corresponds to the delay time set in the distance measurement code delay unit 311, by selectively detecting the frequency components of the “input signal d” that are the same as those of the “signal a” outputted from the signal source 303. Here, even when there exist undesired radio waves emitted from another radar apparatus and wireless apparatus using the same frequency band, no signal is converted into a narrow-band signal by the reception spreading modulation unit 309 other than the one spread-modulated using the same code with the same phase as the “PN code f” which is outputted from the distance measurement code delay unit 311. This indicates that the above-described spread spectrum radar apparatus has a favorable feature of not being seriously affected by undesired radio waves when performing an object detection operation.

However, such conventional technology has a problem that the operation characteristics of the radar apparatus are deteriorated due to the leakage of an input signal to an output at the transmission spreading modulation unit 304 and the reception spreading modulation unit 309. FIG. 2A to FIG. 2D are diagrams, each showing the frequency components of a signal at each unit shown in FIG. 1.

Here, the “signal b” outputted from the transmission spreading modulation unit 304 includes, in actuality, components (a narrow-band signal 353) leaked from a narrow-band signal 351 inputted to the transmission spreading modulation unit 304, in addition to a spread signal 352. Since the peak power of the narrow-band signal 353 is required to be within the limit of the emission intensity of radio waves per unit frequency, stipulated by laws and regulations, it is necessary to suppress the peak power of the narrow-band signal 353 by, for example, providing an attenuator in between the transmission antenna 306 and the transmission unit 305. As a result, the capability of object detection is deteriorated since it is consequently necessary to control the whole electric power to be transmitted, including signal components which are necessary for object detection and which have been spread over a wide band, in addition to suppressing the peak power of the narrow-band signal 353. In other words, the leaked narrow-band signal 353 seriously diminishes an intrinsic advantage of the conventional spread spectrum radar apparatus of being able to minimize a per-unit frequency electric power included in a detection radio wave. Furthermore, the narrow-band signal, which has been leaked from the transmitter side without undergoing spreading modulation, is received also at the receiver side to be despread. At this time, in the case where the input signal inputted to the reception spreading modulation unit 309 synchronizes with the pseudo-noise code, a narrow-band signal 354 is outputted from the reception spreading modulation unit 309, whereas in the case where those pseudo-noise codes do not synchronize with each other, the narrow-band signal, which has been leaked from the transmitter side without undergoing spreading modulation, leaks directly to an output of the reception spreading modulation unit 309 (a narrow-band signal 356), although such leakage is only a little amount. Such leaked narrow-band signal 356 has not undergone the spreading modulation that uses the PN codes, and is outputted independently of the intrinsic operation of the conventional spread spectrum radar apparatus of selectively receiving only a detection radio wave which has undergone propagation delay by a specific delay amount. As a result, the performance of object detection is deteriorated.

FIG. 3 is a diagram showing the signal intensity of the frequency components of the “signal d” outputted from the reception spreading modulation unit 309 that are the same as those of the “signal a” outputted from the signal source 303, the signal intensity being illustrated in connection with the delay amount of the distance measurement code delay unit 311. When the delay amount equals to the propagation delay time of a detection radio wave, the signal intensity increases (a signal 361) since the signal which has been spread over a wide band as a detection radio wave is despread so as to reconstruct the narrow-band signal. However, even when the delay amount does not equal to the propagation delay time of the detection radio wave, signals (signals 362 and 363) which are generated due to the signal leakage at the transmission spreading modulation 304 and the reception spreading modulation 309, are observed.

Here, when there are plural reflection objects, there occurs a problem of becoming unable to perform object detection because a signal from an object with a weaker reflective power is interfered with by a leaked narrow-band signal included in a signal reflected from an object with a stronger reflective power.

The above-described problems attributable the operation characteristics can be fatal defects that impair safety since it may become impossible to detect an object with a weaker reflective power, such as a pedestrian at a close location, due to a stronger signal reflected from an object with a stronger reflective power, such as a heavy vehicle at a distant location.

### SUMMARY OF THE INVENTION

In view of the above problems, it is an object of the present invention to provide a sophisticated spread spectrum radar apparatus with a high capability of object detection, the apparatus being capable of suppressing leakage of a narrow-band signal.

In order to achieve the above object, a spread spectrum radar apparatus of the present invention is a spread spectrum radar apparatus that detects an object by use of a detection radio wave which is a spectrum-spread radio wave used for object detection, the apparatus including: a pseudo-noise code generation unit that generates two or more pseudo-noise codes which are respectively different, based on a timing signal; a spreading modulation unit that generates a spread signal by modulating a signal having a predetermined frequency in plural stages, using the two or more pseudo-noise codes individually in the respective stages; and a transmission unit that emits the spread signal as the detection radio wave.

With this structure, since the leakage of a narrow-band signal to a detection radio wave is suppressed, it is possible to solve the following problems with the conventional spread spectrum radar apparatus attributable to the leaked narrow-band signal: its intrinsic advantage of being able to minimize a per-unit frequency electric power included in a detection radio wave is seriously diminished; and the object detection capability of the conventional spread spectrum radar apparatus is deteriorated since the leaked narrow-band signal requires it to control the whole electric power to be transmitted, including signal components necessary for an object detection operation, in order to satisfy the limit of the emission intensity of radio waves per unit frequency stipulated by laws and regulations.

Furthermore, in order to achieve the above object, the spread spectrum radar apparatus of the present invention is a spread spectrum radar apparatus that detects an object by use of a detection radio wave which is a spectrum-spread radio wave used for object detection, the apparatus including: a pseudo-noise code generation unit that generates two or more pseudo-noise codes which are respectively different, based on a timing signal; a reception unit that receives, as a received signal, the detection radio wave reflected back from the object; a despreading modulation unit that generates a despread signal by modulating the received signal, using the two or more pseudo-noise codes individually in the respective stages; and a signal processing unit that detects presence of the object in accordance with a signal intensity of at least a specific frequency component, based on the despread signal.

With this structure, even when a narrow-band signal is leaked to a spectrum-spread detection radio wave, since components of the narrow-band signal leaked to the detection radio wave are suppressed through plural despreading processes performed at the receiver side, it is possible to suppress a signal that is outputted independently of an intrinsic radar operation of selectively receiving, at the receiver side, only a radio wave which has undergone propagation delay by a specific delay amount. Therefore, it is possible to solve the problems with the conventional spread spectrum radar apparatus of becoming unable to perform object detection because a signal from an object with a weaker reflective power is interfered with by a leaked narrow-band signal included in a signal reflected from an object with a stronger reflective power.

Note that the present invention may be embodied not only as a spread spectrum radar apparatus, but also as a detection method utilizing a spectrum-spread radio wave (such method is hereinafter referred to as a spread spectrum detection method), and the like.

As described above, according to the present invention, it is possible to provide a spread spectrum radar apparatus with an excellent capability of object detection, the apparatus being capable of suppressing, at the transmitter side, the leakage of a narrow-band signal that is irrelevant to a radar detection operation to a detection radio wave as well as capable of suppressing, at the receiver side, the leaked signal that is outputted independently of an intrinsic radar operation of selectively receiving only a radio wave which has undergone propagation delay by a specific delay amount.

### FURTHER INFORMATION ABOUT TECHNICAL BACKGROUND TO THIS APPLICATION

The disclosure of Japanese Patent Application No. 2005-182616 filed on Jun. 22, 2005 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a diagram showing a structure of a spread spectrum radar apparatus according to a conventional technology;

FIG. 2A is a diagram showing a frequency spectrum of a signal from a signal source of the spread spectrum radar apparatus according to the conventional technology;

FIG. 2B is a diagram showing a frequency spectrum of an output signal from a transmission spreading modulation unit of the spread spectrum radar apparatus according to the conventional technology;

FIG. 2C is a diagram showing a frequency spectrum of an output signal from a reception spreading modulation unit of the spread spectrum radar apparatus according to the conventional technology, in the case where an input signal inputted to the reception spreading modulation unit synchronizes with a pseudo-noise code;

FIG. 2D is a diagram showing a frequency spectrum of an output signal from the reception spreading modulation unit of the spread spectrum radar apparatus according to the conventional technology, in the case where an input signal inputted to the reception spreading modulation unit does not synchronize with a pseudo-noise code;

FIG. 3 is a diagram showing the signal intensity of the frequency components of the output signal from the reception spreading modulation unit of the spread spectrum radar apparatus according to the conventional technology that are the same as those of a signal outputted from the signal source, the signal intensity being illustrated in connection with the delay amount of a distance measurement code delay unit;

FIG. 4 is a diagram showing the case where a spread spectrum radar apparatus according to an embodiment of the present invention is embodied as an on-vehicle radar apparatus;

FIG. 5 is a diagram showing a structure of the spread spectrum radar apparatus according to an embodiment of the present invention;

FIG. 6A is a diagram showing a frequency spectrum of a signal from a signal source of the spread spectrum radar apparatus according to the embodiment of the present invention;

FIG. 6B is a diagram showing a frequency spectrum of an output signal from a first transmission spreading modulation unit of the spread spectrum radar apparatus according to the embodiment of the present invention;

FIG. 6C is a diagram showing a frequency spectrum of an output signal from a second transmission spreading modulation unit of the spread spectrum radar apparatus according to the embodiment of the present invention;

FIG. 6D is a diagram showing a frequency spectrum of an input signal of a despreading modulation unit of the spread spectrum radar apparatus according to the embodiment of the present invention;

FIG. 6E is a diagram showing a frequency spectrum of an output signal of the despreading modulation unit of the spread spectrum radar apparatus according to the embodiment of the present invention, in the case where the phases of spreading codes synchronize with each other;

FIG. 6F is a diagram showing a frequency spectrum of an output signal of the despreading modulation unit of the spread spectrum radar apparatus according to the embodiment of the present invention, in the case where the phases of spreading codes do not synchronize with each other;

FIG. 7 is a diagram showing the signal intensity of the frequency components of the output signal from the despreading modulation unit of the spread spectrum radar apparatus according to the embodiment of the present invention that are the same as those of a signal outputted from the signal source, the signal intensity being illustrated in connection with the delay amount of a distance measurement code delay unit;

FIG. 8 is a diagram showing a structure of a spread spectrum radar apparatus according to another embodiment of the present invention.

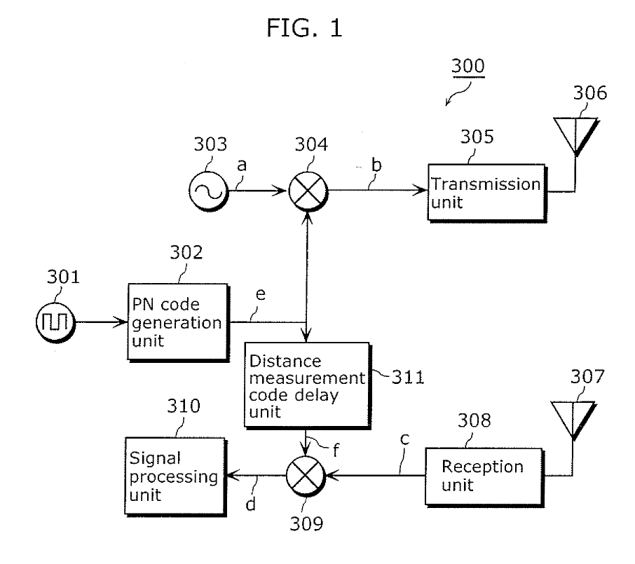

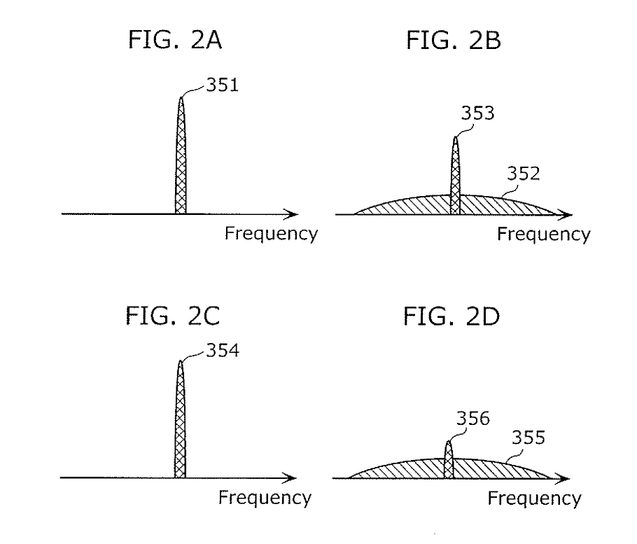

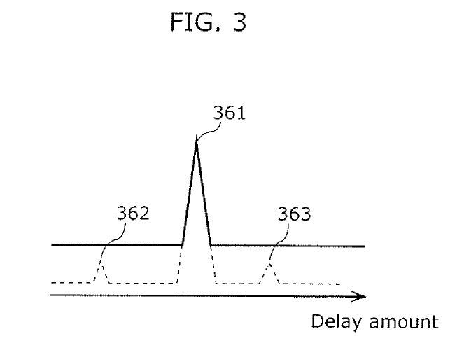

### DESCRIPTION OF THE PREFERRED EMBODIMENT

### Embodiment

The following describes a preferred embodiment of the present invention with reference to the drawings.

The spread spectrum radar apparatus according to an embodiment of the present invention is (a) a spread spectrum radar apparatus that detects an object by use of a detection radio wave which is a spectrum-spread radio wave used for object detection, the apparatus (b) generating two or more transmitter pseudo-noise codes which are respectively different and two or more receiver pseudo-noise codes which are respectively different, based on a timing signal, (c) generating a spread signal by modulating a signal having a predetermined frequency in plural stages, using the two or more transmitter pseudo-noise codes individually in the respective stages, (d) emitting the spread signal as the detection radio wave, (e) receiving, as a received signal, the detection radio wave reflected back from the object, (f) generating a despread signal by modulating the received signal, using the two or more receiver pseudo-noise codes individually in the respective stages, and (g) detecting the presence of the object in accordance with a signal intensity of at least a specific frequency component, based on the despread signal.

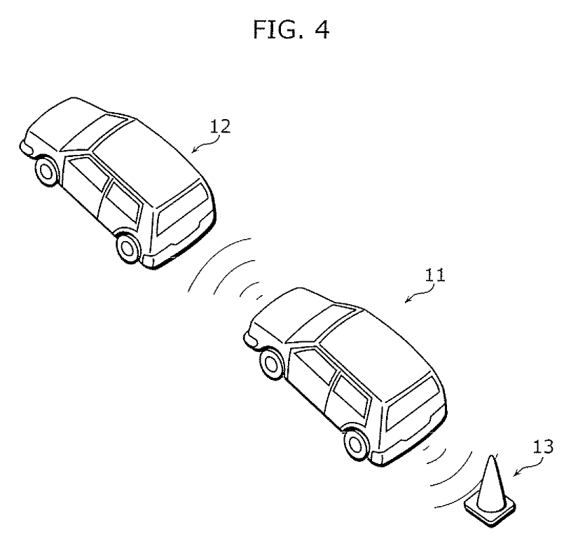

For example, as shown in FIG. 4, the spread spectrum radar apparatus according to the present embodiment is equipped at the front and tail of a vehicle 11. The spread spectrum radar apparatus emits a detection radio wave for object detection to an object such as a preceding vehicle 12 and an obstruction 13, receives a detection radio wave reflected from the object, and determines the presence/absence of an obstruction, a distance from the obstruction, and a relative speed, based on the received detection radio wave.

Based on the above points, the spread spectrum radar apparatus of the present embodiment is described hereafter.

First, the structure of the spread spectrum radar apparatus of the present embodiment is described.

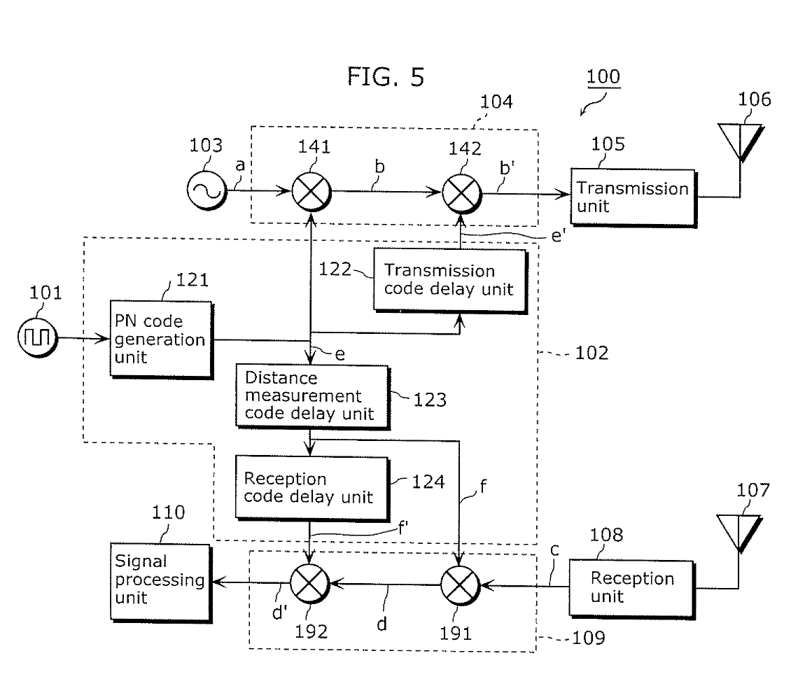

As shown in FIG. 5, a spread spectrum radar apparatus 100 includes a timing generation unit 101, a pseudo-noise code generation unit 102, a signal source 103, a spreading modulation unit 104, a transmission unit 105, a transmission antenna 106, a reception antenna 107, a reception unit 108, a despreading modulation unit 109, a signal processing unit 110, and the like.

Furthermore, the pseudo-noise code generation unit 102 includes a PN code generation unit 121, a transmission code delay unit 122, a distance measurement code delay unit 123, a reception code delay unit 124, and the like.

The PN code generation unit 121 generates a “pseudo-noise code (hereinafter also referred to as a “PN code”) e” based on a timing signal generated by the timing generation unit 101.

The transmission code delay unit 122 outputs a “PN code e′”, which is different from the “PN code e”, by delaying the “PN code e” generated by the PN generation unit 121.

The distance measurement code delay unit 123 outputs a “PN code f”, which is different from the “PN code e”, by delaying the “PN code e” generated by the PN generation unit 121.

The reception code delay unit 124 outputs a “PN code f′”, which is different from the “PN code f”, by delaying the “PN code f” outputted from the distance measurement code delay unit 123.

At the transmitter side, the spreading modulation unit 104 performs spread spectrum modulation on a narrow-band signal generated by the signal source 103, using the PN code generated by the pseudo-noise code generation unit 102, so as to convert it into a wide-band signal. After this, the transmission unit 105 performs signal processing, such as frequency transform and amplification, on the wide-band signal where necessary. The resulting signal is outputted from the transmission antenna 106 as an object detection radio wave. At the receiver side, the reception antenna 107 receives a detection radio wave reflected from the object. Then, the reception unit 108 performs processing, such as low-noise amplification and frequency transform, on the received detection radio wave where necessary. The despreading modulation unit 109 performs despreading modulation on the resulting radio wave, using the code obtained by the distance measurement code delay unit 123 by delaying the pseudo-noise code generated by the pseudo-noise code generation unit 102. The signal processing unit 110 selects the same frequency components as those included in the signal generated by the signal source 103 at the transmitter side, from among the frequency components included in the “signal d′” outputted from the despreading modulation unit 109, and detects the presence/absence of the object by measuring the intensity of such selected components.

Here, the spreading modulation unit 104 includes a first transmission spreading modulation unit 141, a second transmission spreading modulation unit 142, and the like. With this structure, even when there is the same level of leakage of an input signal at the first transmission spreading modulation unit 141 as the leakage occurring in the transmission spreading modulation unit 304 of the conventional spread spectrum radar apparatus 300, the second transmission spreading modulation unit 142 at the second stage makes it possible to achieve a dramatic reduction, on the whole spreading modulation unit 104 level, in the amount of the leakage of the “narrow-band input signal a” to the “output signal b′”. For example, consider the case where general doubly balanced mixers are used as the first transmission spreading modulation unit 141 and second transmission spreading modulation unit 142. In the case where only one doubly balanced mixer is used, isolation between the input side and the output side is some 20 dB, whereas in the case where two serially-connected doubly balanced mixers are used, the whole isolation is 40 dB, thereby reducing the leakage of electric power to the output side to one-hundredth of the conventional technology.

Moreover, the despreading modulation unit 109 includes a first reception spreading modulation unit 191, a second reception spreading modulation unit 192, and the like. According to the same operating principle as that of the spreading modulation unit 104, this structure makes it possible to achieve a dramatic suppression of signal components leaking from the input side to the output side on the whole despreading modulation unit 109 level. For example, consider the case where general doubly balanced mixers are used as the first reception spreading modulation unit 191 and second reception spreading modulation unit 192. In the case where only one doubly balanced mixer is used, isolation between the input side and the output side is some 20 dB, whereas in the case where two serially-connected doubly balanced mixers are used, the whole isolation is 40 dB, thereby reducing the leakage of electric power to the output side to one-hundredth of the conventional technology.

Here, a description is given of the principle according to which the spread spectrum radar apparatus of the present invention measures a distance.

In the spread spectrum radar apparatus 100, plural spreading modulation units are serially connected, as in the case of the first transmission spreading modulation unit 141 and the second transmission spreading modulation unit 142 of the spreading modulation unit 104, and different pseudo-noise codes are provided to the respective spreading modulation units so as to perform multi-stage spreading modulation.

This structure makes it possible to achieve an ideal processing result with reduced signal leakage that occurs between the input side and the output side in each of the transmission spreading modulation units. Moreover, the result to be obtained through spreading modulation performed by the spreading modulation unit 104 is substantially the same as the result obtained by performing a single-stage spreading modulation on an input signal, using a single code obtained by performing exclusive OR on pseudo-noise codes (spreading codes) provided to the respective transmission spreading modulation units.

In the transmitter side, as codes used for spreading modulation, a “PN code e” generated by the single PN code generation unit 121 is used by the first transmission spreading modulation unit 141 to perform spreading modulation, after which a “PN code e′” obtained by the transmission code delay unit 122 delaying the same “PN code e” is used by the second transmission spreading modulation unit 142 to perform spreading modulation. As a result, the “output signal b′” is substantially obtained by performing spreading modulation on an “input signal a” using a code that is obtained by performing exclusive OR on the “PN code e” and the “PN code e′” obtained by delaying the “PN code e”.

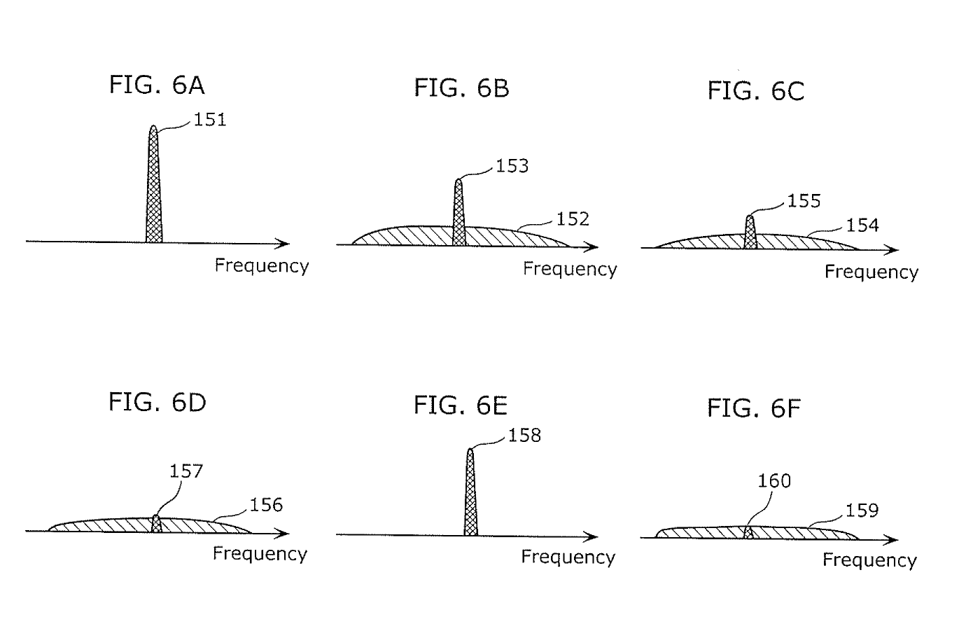

More specifically, as shown in FIG. 6A, when receiving an input of the “signal a” from the signal source 103, i.e., a narrow-band signal 151, the first transmission spreading modulation unit 141 spreads the narrow-band signal 151, using the “PN code e” provided from the PN code generation unit 121, and outputs the “signal b”.

When this is done, as shown in FIG. 6B, the “signal b” outputted from the first transmission spreading modulation unit 141 includes a narrow-band signal 153, which is the leakage of the narrow-band signal 151 provided from the signal source 103, in addition to a spread signal 152 actually obtained through spreading modulation.

Also, when receiving an input of the “signal b” outputted from the first transmission spreading modulation unit 141, i.e., the spread signal 152 and narrow-band signal 153, the second transmission spreading modulation unit 142 spreads the spread signal 152 and the narrow-band signal 153, using the “PN code e′” outputted from the transmission code delay unit 122, and outputs the “signal b′”.

When this is done, as shown in FIG. 6C, the “signal b′” outputted from the second transmission spreading modulation unit 142 includes a narrow-band signal 155, which is a small leakage of the narrow-band signal 153 provided from the first transmission spreading modulation unit 141, in addition to a spread signal 154 actually obtained through spreading modulation.

Here, in the case where an M-sequence code is used as the “PN code e”, an “output signal b′” is substantially obtained as the result of performing a single-stage spreading modulation on the “input signal a”, using a code that is obtained by delaying the original “PN code e”. Thus, the use of an M-sequence code makes it possible to directly inherit a feature of M-sequence code that is desirable from the standpoint of operations of the radar apparatus, such as excellent autocorrelation.

Such a feature is based on the following property: an exclusive OR between an M-sequence code generated from a certain generating polynomial and another M-sequence code that has a different phase and that is generated from the same generating polynomial results in a code obtained by delaying the original M-sequence code. In other words, the above feature is based on the property that an exclusive OR between the original M-sequence code and a code obtained by delaying the original M-sequence code results in a code obtained by delaying the original M-sequence code. Through the use of such mathematical characteristics of M-sequence code, even when multi-stage spreading modulation is performed, the same result is obtained as that of performing a single-stage spreading modulation using an M-sequence code that is different from the original M-sequence code only in phase. Thus, it is possible to inherit excellent features of M-sequence code.

Furthermore, supposing that the isolation between the input and output sides in each of the first transmission spreading modulation unit 141 and the second transmission spreading modulation unit 142 is some 20 dB, it is possible to reduce the electric power of the narrow-band signal 155 to one hundredth compared to the narrow-band signal 151, and thus to minimize the influence caused by components that leak without being spread.

At the receiver side too, on the similar principle, while suppressing signal leakage between the input and output sides on the whole despreading modulation 109 level by performing two-stage despreading modulation through the first reception spreading modulation unit 191 and the second reception spreading modulation unit 192, the same result is substantially obtained as that obtained by performing a single-stage despreading modulation using a code that is obtained by delaying the “PN code f”.

More specifically, as shown in FIG. 6D, when receiving an input of the “signal d” outputted from the first reception spreading modulation unit 191, i.e., the spread signal 156 and narrow-band signal 157, the second reception spreading modulation unit 192 despreads the spread signal 156 and the narrow-band signal 157, using the “PN code f′” outputted from the reception code delay unit 124, and outputs the “signal d′”.

When this is done, when autocorrelation is obtained while changing the delay amount by the distance measurement code delay unit 123, a narrow-band signal 158 is reconstructed as shown in FIG. 6E. On the other hand, when autocorrelation is not obtained, a signal including a spread signal 159 and a narrow-band signal 160 is obtained as shown in FIG. 6F.

Through the above principle, signal processing to be performed is substantially the same as that of the conventional spread spectrum radar apparatus, although multi-stage spreading modulation is performed at the transmitter side or multi-stage despreading modulation is performed at the receiver side. Therefore, in the case where the delay amount of a substantial receiver spreading code corresponding to a substantial transmitter spreading code equals to the propagation delay amount of an object detection radio wave, the object detection radio wave spread over a wide band is to be despread, and the narrow-band signal generated by the signal source 103 at the transmitter side is reproduced as the “signal d′” outputted from the despreading modulation unit 109. The signal processing unit 110 can detect the presence of an object by selectively detecting the frequency components that are included in the frequency components generated by the signal source 103, out of the frequency components included in the “signal d′” outputted from the despreading modulation unit 109.

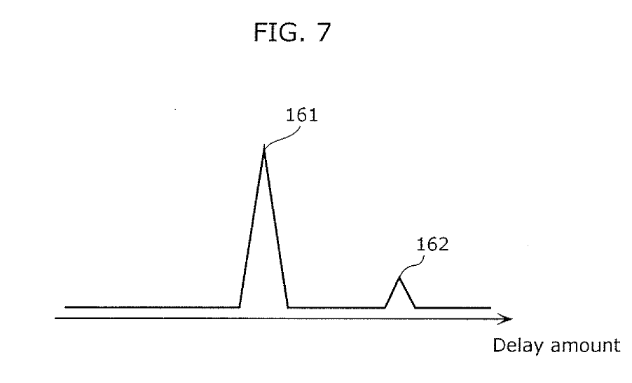

For example, as shown in FIG. 7, when the delay amount equals to the propagation delay time of a detection radio wave, the signal intensity increases (a signal 161) since the signal which has been spread over a wide band as a detection radio wave is despread so as to reconstruct the narrow-band signal. Furthermore, thanks to the suppression of signal leakage, it is possible to observe a signal which is hidden behind a leaked signal in the conventional technology (a signal 162), and thus the capability of object detection improves.

Here, time delay between the PN code e provided to the transmitter side and the transmitter spreading code corresponding to a substantially single-stage spreading modulation performed by the spreading modulation unit 104, is uniquely determined by the delay amount applied by the transmission code delay unit 122, and time delay between the “PN code f” provided to the receiver side via the distance measurement code delay unit 123 and a substantial receiver spreading code corresponding to a substantially single-stage despreading modulation performed by the despreading modulation unit 109, is uniquely determined by the delay amount applied by the reception code delay unit 124. Thus, by taking into consideration these delay amounts in advance, it is possible to determine the propagation delay time of an object detection radio wave corresponding to the delay time set to the distance measurement code delay unit 123.

In particular, by using the same delay amount for the delay amount applied by the transmission code delay unit 122 and for the delay amount applied by the reception code delay unit 124, it is possible to set the same time difference for the time difference between the “PN code e” and the substantial transmitter spreading code in the spreading modulation unit 104 and for the time difference between the “PN code f” and the substantial receiver spreading code in the despreading modulation unit 109. Thus, it is possible to make a direct association between the round trip time delay of the object detection radio wave and delay time set to the distance measurement code delay unit 123.

As described above, the spread spectrum radar apparatus of the present embodiment has an excellent capability of object detection since it is capable of suppressing, at the transmitter side, the leakage of a narrow-band signal that is irrelevant to a radar detection operation to a detection radio wave as well as capable of suppressing, at the receiver side, the leaked signal that is outputted independently of an intrinsic radar operation of selectively receiving only a radio wave which has undergone propagation delay by a specific delay amount.

(Others)

Note that M sequence codes generated from respectively different generating polynomials may be provided to the respective spreading modulation units in the multi-stage spreading modulation. In this case, the result to be substantially achieved is the one obtained by performing a single-stage spreading modulation using a code that is generated through linear combination of these M sequence codes. Such a code generated through linear combination of plural M sequence codes generated from different generating polynomials is referred to as a gold code. The use of gold code makes it possible to generate many mutually independent sequences, and thus to provide a favorable feature of being able to realize many radar apparatuses which do not interfere with each other.

Furthermore, other codes than the codes described above may be used in the multi-stage spreading modulation. In this case, any codes may be used to allow enjoy the advantage, serving as an essential feature of the present invention, of being able to suppress signal leakage between the input and output sides, as long as the autocorrelation characteristics of a substantial spreading code that is generated through exclusive OR between codes provided to the respective spreading modulation units in the multi-stage spreading modulation, are suited to radar operations.

Moreover, although the above-described embodiment of the present invention presents an example case where two-stage spreading modulation is carried out both at the transmitter side and the receiver side, it is possible to improve the performance of the radar apparatus on the whole, as long as multi-stage spreading modulation units are structured in at least one of the transmitter side and the receiver side. For example, it is possible that two-stage spreading modulation units are structured only at the transmitter side and a single-stage spreading modulation unit is structure at the receiver side.

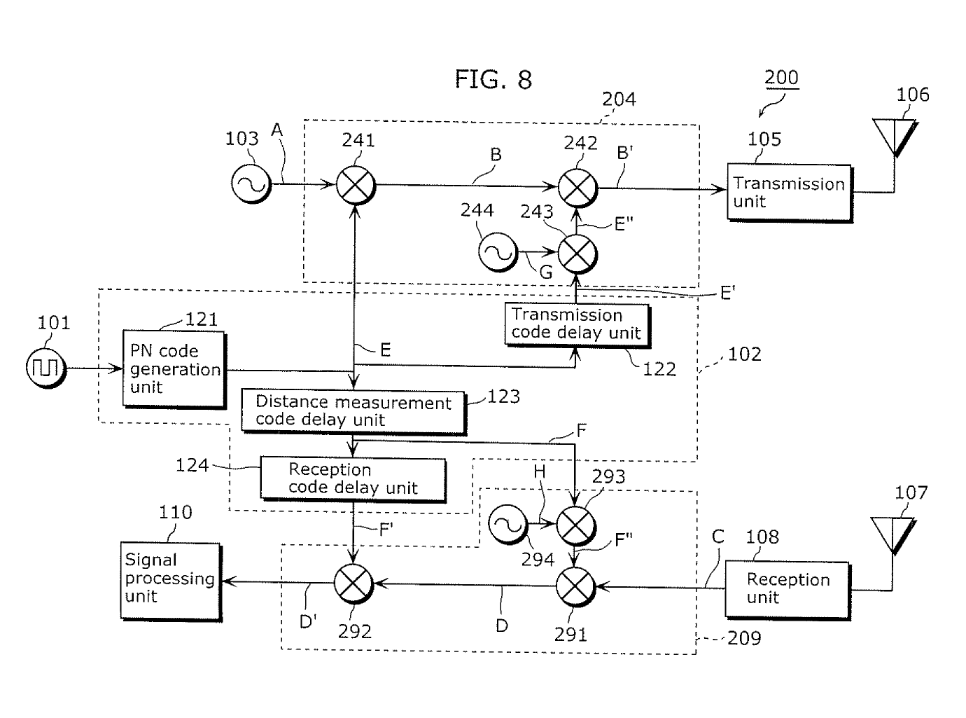

Furthermore, the respective spreading modulation units may be integrated with frequency transform. For example, as shown in FIG. 8, the following structure may be employed: a local oscillator 244 is provided at the transmitter side; a transmission spreading modulation unit 243 generates a “signal E″” by spreading a “local oscillation signal G” from the local oscillator 244 using a “spreading code E′”; and a second spreading modulation unit 242 performs spreading modulation on an “input signal B” using the “signal E″”; so as to generate an “output signal B′”. In this case, although spreading to be performed using the “spreading code E′” and frequency transform to be performed using the “local oscillation signal G” are carried out in an integrated manner, this integration can be used as an operation of one of the spreading modulation units of the present invention, since spreading modulation is substantially performed on the “input signal B”, using the “spreading code E′”.

Similarly, as shown in FIG. 8, the following structure may be employed: a local oscillator 294 is provided also at the receiver side; a reception spreading modulation unit 293 generates a “signal F″” by spreading a “local oscillation signal H” from the local oscillator 294 using a “spreading code F”; and a first reception spreading modulation unit 291 performs spreading modulation on an “input signal C”, using the “spreading code F″”, so as to generate an “output signal D”. In this case, although spreading to be performed using the “spreading code F” and frequency transform to be performed using the “local oscillation signal H” are carried out in an integrated manner, this integration can be used as an operation of one of the spreading modulation units of the present invention since spreading modulation is substantially performed on the “input signal C”, using the “spreading code F”.

Note that the present invention may be embodied not only as a spread spectrum radar apparatus, but also as a detection method utilizing a spectrum-spread radio wave, and the like.

Also note that the present invention may not only be embodied as a single unit spread spectrum radar apparatus but also separately as the transmitter function and as the receiver function of the spread spectrum radar apparatus.

Moreover, the despreading modulation unit 109 may only include at least one spreading modulation unit as long as the spreading modulation unit 104 includes two or more spreading modulation units which are serially connected. In other words, as long as the “output signal b′” is generated at the transmitter side through plural spreading processes, the “output signal d′” may be generated through a single despreading process at the receiver side without having to undergo plural despreading processes. This structure makes it possible to perform plural spreading processes on a leaked narrow-band signal at the transmitter side and to suppress such narrow-band signal before it is emitted as a detection radio wave.

Similarly, the spreading modulation unit 104 may only include at least one spreading modulation unit as long as the despreading modulation unit 109 includes two or more spreading modulation units which are serially connected. In other words, as long as the “output signal d′” is generated at the receiver side thorough plural despreading processes, the “output signal b′” may be generated at the transmitter side through a single spreading process without having to undergo plural spreading processes. This structure makes it possible to perform plural despreading processes on a leaked narrow-band signal that has not been spread at the receiver side and to suppress such narrow-band signal before it is inputted into the signal processing unit 110.

Although only an exemplary embodiment of this invention has been described in detail above, those skilled in the art will readily appreciate that many modifications are possible in the exemplary embodiment without materially departing from the novel teachings and advantages of this invention. Accordingly, all such modifications are intended to be included within the scope of this invention.

### INDUSTRIAL APPLICABILITY

The present invention is applicable for use as a sophisticated spread spectrum radar apparatus with a high capability of object detection.

What is claimed is:

1. A spread spectrum radar apparatus that detects an object by use of a detection radio wave which is a spectrum-spread radio wave used for object detection, said apparatus comprising:
a pseudo-noise code generation unit operable to generate two or more pseudo-noise codes which are respectively different, based on a timing signal;
a spreading modulation unit operable to generate a spread signal by modulating a signal having a predetermined frequency in plural stages, using the two or more pseudo-noise codes individually in the respective stages; and
a transmission unit operable to emit the spread signal as the detection radio wave.

2. The spread spectrum radar apparatus according to claim 1,
wherein said pseudo-noise code generation unit is operable to generate, as the two or more pseudo-noise codes, M sequence codes.

3. The spread spectrum radar apparatus according to claim 1,
wherein said pseudo-noise code generation unit is operable to generate, as the two or more pseudo-noise codes, M sequence codes of a single type, the M sequence codes having respectively different delay amounts and being generated based on the same generating polynomial.

4. The spread spectrum radar apparatus according to claim 1,
wherein said pseudo-noise code generation unit is operable to generate, as the two or more pseudo-noise codes, M sequence codes of plural types, the M sequence codes being generated based on respectively different generating polynomials.

5. A spread spectrum radar apparatus that detects an object by use of a detection radio wave which is a spectrum-spread radio wave used for object detection, said apparatus comprising:
a pseudo-noise code generation unit operable to generate two or more pseudo-noise codes which are respectively different, based on a timing signal;
a reception unit operable to receive, as a received signal, the detection radio wave reflected back from the object;
a despreading modulation unit operable to generate a despread signal by modulating the received signal, using the two or more pseudo-noise codes individually in the respective stages; and
a signal processing unit operable to detect presence of the object in accordance with a signal intensity of at least a specific frequency component, based on the despread signal.

6. The spread spectrum radar apparatus according to claim 5,
wherein said pseudo-noise code generation unit is operable to generate, as the two or more pseudo-noise codes, M sequence codes.

7. The spread spectrum radar apparatus according to claim 5,
wherein said pseudo-noise code generation unit is operable to generate, as the two or more pseudo-noise codes, M sequence codes of a single type, the M sequence codes having respectively different delay amounts and being generated based on the same generating polynomial.

8. The spread spectrum radar apparatus according to claim 5,
wherein said pseudo-noise code generation unit is operable to generate, as the two or more pseudo-noise codes, M sequence codes of plural types, the M sequence codes being generated based on respectively different generating polynomials.

9. A spread spectrum radar apparatus that detects an object by use of a detection radio wave which is a spectrum-spread radio wave used for object detection, said apparatus comprising:
a pseudo-noise code generation unit operable to generate two or more transmitter pseudo-noise codes which are respectively different and two or more receiver pseudo-noise codes which are respectively different, based on a timing signal;
a spreading modulation unit operable to generate a spread signal by modulating a signal having a predetermined frequency in plural stages, using the two or more transmitter pseudo-noise codes individually in the respective stages;
a transmission unit operable to emit the spread signal as the detection radio wave;
a reception unit operable to receive, as a received signal, the detection radio wave reflected back from the object;
a despreading modulation unit operable to generate a despread signal by modulating the received signal, using the two or more receiver pseudo-noise codes individually in the respective stages; and
a signal processing unit operable to detect presence of the object in accordance with a signal intensity of at least a specific frequency component, based on the despread signal.
